(19) United States
(12) Patent Application Publication
(10) Pub. No.: US 2016/0092882 A1
(43) Pub. Date: Mar. 31, 2016

(54) SYSTEM, DEVICES, AND METHODS FOR PROVIDING A PRODUCT RECALL NOTICE TO A CONSUMER

(71) Applicant: Kerry Lee Small, State College, PA (US)

(72) Inventor: Kerry Lee Small, State College, PA (US)

(21) Appl. No.: 14/501,937

(22) Filed: Sep. 30, 2014

(51) Int. Cl. G06Q 30/00

(52) U.S. Cl. CPC G06Q 30/014

(57) ABSTRACT

Systems, devices, and methods for providing a product recall notice to a consumer are disclosed. Embodiments include receiving consumer identification information and product identification information from a mobile computing device at a computer server as well as storing and associating the product identification information in a consumer products database with the consumer identification information. Further, a request is transmitted and a response received from a third party database that includes a product recall notice. Based on the product recall notice message, a message is generated that notifies a consumer of the product recall notice.

### BACKGROUND OF THE INVENTION

Consumers purchase different products through a variety of sales channels that include e-commerce via the Internet through both desktop and mobile devices (e.g. smartphone, tablet, laptop computing devices, etc.) as well as from point-of sale (POS) terminals at retail stores. Further, many consumers prefer to receive product recall notices for their purchased products. However, many product manufacturers may have trouble locating a consumer that has purchased their product to provide the consumer with a product recall notice (e.g. unregistered consumer, consumer purchased through secondary/used sales channels, etc.). In addition, the product manufacturer may not be the entity that issues a product recall for a product. Instead a government entity or independent agency may have evaluated a product an issued a product recall notice. Such a government entity or independent agency may not be able to locate a consumer that purchased the recalled notice.

Accordingly, there is a need for systems, devices, and methods for providing a product recall notice to a consumer.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system for providing a product recall notice to a consumer in accordance with some embodiments.

FIG. 2 is a block diagram of a device used in a system for providing a product recall notice to a consumer in accordance with some embodiments.

FIG. 3 is a block diagram of a device used in a system for providing a product recall notice to a consumer in accordance with some embodiments.

FIG. 4 is a flowchart of a method of providing a product recall notice to a consumer in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

The illustrative embodiments described in the detailed description, drawings, and claims are not meant to be limiting. Other embodiments may be utilized, and other changes may be made, without departing from the scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

Systems, devices, and methods for providing a product recall notice to a consumer are disclosed. Embodiments include capturing an image of a portion of a product using a mobile computing device and determining product identification information related to the product using the mobile computing device. Further embodiments include receiving consumer identification information and product identification information from the mobile computing device at a computer server as well as storing the product identification information in a consumer products database based on the consumer identification information and linking or associating the consumer identification information with the product identification information in the consumer products database using the computer server. Additional embodiments include transmitting one or more requests from the computer server to a third party database at one or more time intervals. Each request is for one or more product recall notices issued since a previous time interval and receiving one or more product recall notices from the third party database using the computer server. Other embodiments include determining the product identification information based on the one or more product recall notices using the computer server, searching the consumer product database using the computer server based on the determined product information, and identifying the consumer identification information based on the determined product identification information using the computer server. Moreover, embodiments include generating a message that includes a notification of the one or more product recall notices for a consumer based on the identified consumer identification information and the one or more product recall notices using the computer server.

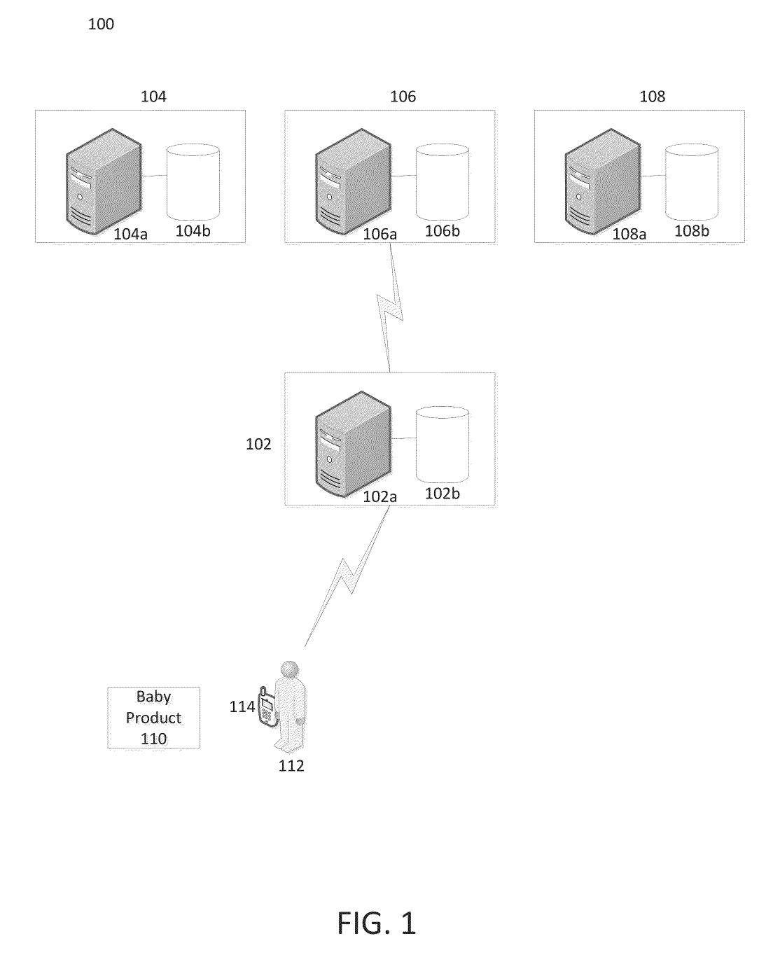

FIG. 1 is a block diagram of a system 100 for providing a product recall notice to a consumer in accordance with some embodiments. The system 100 includes a consumer 112 having a mobile computing device 114 and purchasing a baby product 110, for example. Further, the system 100 includes a computer server 102 that includes one or more computer server devices 102a and/or a database 102b. In addition, system 100 includes third party computer servers (104, 106, 108) each having one or more computer server devices (104a, 106a, 108a) and/or one or more databases (104b, 106b, 108b). In one embodiment, the baby product 110 may have been purchased by the consumer 112 or the consumer 112 is contemplating to purchase through one of a variety of sales channels (e-commerce via Internet, retail store, etc.). The mobile computing device 114 may include an image capture device (e.g. camera) that allows the consumer 112 to capture an image of a portion of a product. Such an image may include a computer readable code (e.g. bar code, QR code, etc.). Using an image processing module and a product identification module (e.g. computer readable code scanner, bar code scanner, QR code scanner, etc.) the mobile computing device 114 determines product identification information related to the product 110. Product information may include at least one of an image of a portion of a product, a bar code associated with the product, Stock Keeping Unit (SKU) code, Universal Product Code (UPC), European Article Number (EAN), Global Trade Item Number (GTIN), Australian Product Number (APN), Electronic Product Code (EPC), manufacturer name, product name, product description, and batch code.

In an alternate embodiment, the consumer 112 may capture an image of the entire or portion of the product 110 using the mobile computing device 114 (e.g. with the camera of the mobile computing device). Further, the mobile computing device 114 may query a search engine, database, and/or any other information repository (e.g. proprietary database) over the Internet or network based on the captured image of the product (or portion thereof). This may include sending the captured image to the search engine or information repository. Such a search engine or information repository may send a response to the mobile computing device 114 that includes product identification information. Alternatively, the mobile computing device 114 may send a query to a database stored in the mobile computing device 114 itself based on the captured image. Such a database may store product identification information.

Further, a consumer may enter (a priori or a posteriori) consumer identification information (e.g. name, address, etc.) into a user interface of the mobile computing device 114. The consumer identification information and product identification information may be transmitted from the mobile computing device 114 to a computer server 102. In addition, the computer server 102 may store the product identification information in a consumer products database 102b based on the consumer identification information and links or associates the consumer identification information with the product identification information in the consumer products database 102b.

Instead of providing consumer identification information and product identification information to a computer server 102 from a mobile computing device 114, a consumer 112 may provide such information to the computer server 102 through other computing devices. Thus, alternate embodiments include purchasing the baby product 110 at a retail store and rendering payment for such a purchase at a point-of-sale terminal. Further, the POS terminal may be equipped with a scanner to capture an image of a portion of the product 110 (e.g. computer readable code, bar code, QR code, etc.) and determine product identification information using the POS terminal. In addition, the consumer 112 or store personnel may enter consumer identification information (e.g. consumer name, address, loyalty card information, credit card information, etc.) into the POS terminal. Moreover, the POS terminal may provide the computer server 102 with the consumer identification information and product identification information.

Other embodiments include a consumer 112 purchasing a product 110 using e-commerce from a computing device such as a tablet, laptop, or desktop computer. Such computing devices may have an image capture device (e.g. screen capture, etc.) to capture an image of the product 110 to determine a product identification information or a consumer 112 may enter product identification information as well as consumer identification information through a user interface through a computing device. The computing device may then provide consumer identification information and product identification information to the computer server 102.

In an additional embodiment, a consumer 112 may purchase a product via an e-commerce channel or at a retail store using a payment card (e.g. a credit card, debit card, gift card, charge card, etc.) associated with a financial institution. The financial institution may (or some other entity) provide a mobile application/module that may be operated on the mobile computing device 114 such that after an e-commerce purchase, the consumer 112 may capture an image of the product (or a portion thereof) and determine the product identification information as described herein the present disclosure. Further, the mobile computing device 114 may provide the determined product identification information to a computer server 102 that may be operated by the financial institution (or some other entity). The computer server 102 may request the consumer 112 for further input to associate a product purchase using the payment card with the determined product identification information and store such an association in a database 102b. In addition, the consumer 112 may provide the computer server with consumer identification information as described herein.

At regular (e.g. hourly, daily, weekly, monthly, etc.) or aperiodic time intervals the computer server 102 may transmit one or more requests from the computer server 102 to a third party database (104b, 106b, 108b) operated by a computer server (104a, 106a, 108a). Each request is for one or more product recall notices issued since a previous time interval. Moreover, the computer server 102 receives one or more product recall notices from the third party database (104b, 106b, and 108b). The third party databases include one or more government databases, one or more manufacturer databases, and one or more independent agency databases (e.g. consumer agency or product watchdog groups).

The computer server 102 determines the product identification information for each product listed in the received one or more received product recall notices. Further, the computer server 102a searches the consumer product database 102b based on the determined product information and identifies the consumer identification information associated with the determined product identification information. Moreover, the computer server 102 generates a message that includes a notification of the one or more product recall notices for a consumer based on the identified consumer identification information and sends such message to the consumer 112 accordingly. The message may be a text message, voice message, email message, fax message, postal message, website update, and RSS.

In different embodiments, computer server 102 may be operated by one or more entities, the one or more entities can be an online retailer, a retail store, manufacturer, and a financial institution. In one embodiment, a computer server 102 operated by a financial institution may receive consumer identification information and product identification information from a POS terminal or a computing device when a consumer 112 purchases a product 110 when using funds or a payment card (e.g. credit card, debit card, gift card, charge card, etc.) associated with the financial institution (e.g. bank, credit card company, credit union, etc.).

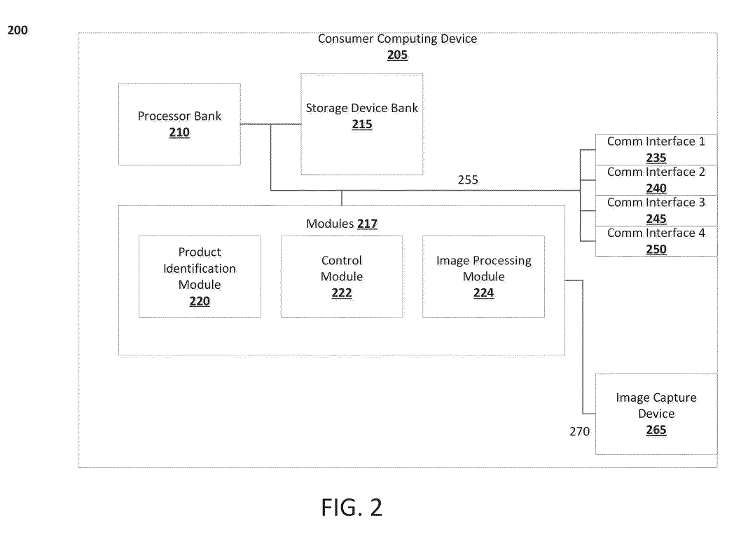

FIG. 2 is a block diagram of a consumer computing device 205 used in a system for providing a product recall notice to a consumer in accordance with some embodiments. Such a consumer computing device 205 may be used in a system shown in FIG. 1 and may be a smartphone, tablet computer, laptop computer, notebook computer, or any other portable computing device as well as a desktop computer or a POS terminal used to purchase a product at a retail store. The consumer computing device 205 may include several different components such as a processor bank 210, storage device bank 215, one or more software applications, which may be executed by a processor to form specifically-configured module devices 217, and one or more communication interfaces (235-250) as well as an image capture device 265 (e.g. camera). The processor bank 210 may include one or more processors that may be co-located with each other or may be located in different parts of the consumer computing device 205. The storage device bank 215 may include one or more storage devices. Types of storage devices may include memory devices, electronic memory, optical memory, and removable storage media. The one or more modules 217 may include a product identification module 220, control module 222, and an image processing module 224. The modules 217 may be implemented by the one or more processors in the processor bank 210.

The image processing module 224 may process an image captured by the image captured device 265. The image processing module 224 may resolve an image or clarify and image as part of the image processing. For example, the image capture device may capture an image of a computer readable code (e.g. bar code, QR code. etc.) of a product and the image processing module 224 may use techniques known in the art to determine the computer readable code. In another example, the image capture device 265 may capture an entire, or portion of, an image of a product. The image processing module 224 may then resolve or clarify the image of the product (or portion thereof).

The product identification module 220 may receive product data from the image processing module, for example, a computer readable code or an image of a product (or a portion thereof). In another example, the product identification module 220 may receive product data from a consumer through a user interface (that may be one of the communication interfaces 235-250). Whether receiving product data from the image processing module 224 or the user interface, the product identification module 220 determines the product identification information based on the received product data. In one embodiment, the product identification module 220 may send a query to a search engine, database, and or any other information repository (e.g. proprietary database) over the Internet or network through one of the communication interfaces 235-250 based on the received product data. This may include sending the captured image to the search engine or information repository. Such a search engine or information repository may send a response to the consumer computing device 205 and product identification module 220 that includes product identification information. Alternatively, the product identification module 220 may send a query to a database stored in the storage device bank 215 based on the received product data. Such a database may send a response to the product identification module 220 that includes product identification information.

The consumer computing device 205 may also receive consumer identification information through the user interface. Upon receiving the consumer identification information, the product identification information and/or consumer instructions, the consumer computing device 205 may transmit the consumer identification information and the product identification information to a computer server over a communication interface 235-250.

A control module 222 may implement hardware and software functions that assist in performing certain tasks for the consumer computing device 205 such as providing access to a communication network, executing an operating system, managing software drivers for peripheral components, processing information, user interface computer programs, debugging and troubleshooting software tools.

Each of the communication interfaces (235-250) may be software or hardware associated in communicating to other devices. The communication interfaces (235-250) may be of different types that include a user interface, USB, Ethernet, WiFi, WiMax, wireless, optical, cellular, or any other communication interface coupled to a communication network. One or more of the communication interfaces (235-250) may be coupled to a user interface known in the art.

An intra-device communication link 255 and 270 between the processor bank 210, storage device bank 215, modules 217, image capture device 265 and communication interfaces (235-250) may be one of several types that include a bus or other communication mechanism.

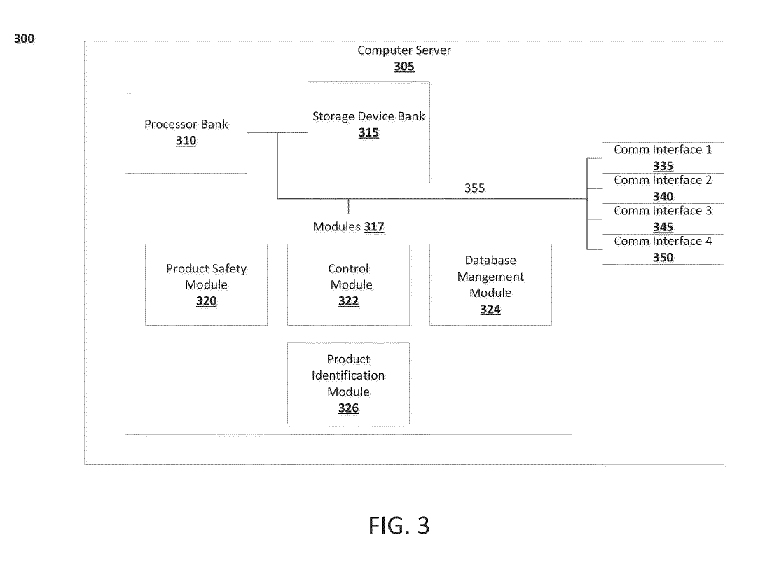

FIG. 3 is a block diagram of a device, such as a computer server 305, used in a system for providing a product recall notice to a consumer in accordance with some embodiments. The computer server 305 may include a database stored in the storage device bank 215 or may be coupled to a database external to the computer server 305. Further, computer server 305 may be part of a computer server system described herein that may include one or more computer servers and one or more databases. In the present disclosure, a computer server may, but not always, refer to embodiments that include a computer server system having one or more computer servers and one or more databases coupled to each other. The one or more computer servers may be co-located with each other or distributed among different locations. Likewise, the one or more one or more databases may be co-located with each other or distributed among different locations. In further embodiments, some of the one or more computer servers may be co-located and coupled to the one or more databases while in additional embodiments some of the one or more computer servers may be coupled to the one or more databases each of which are placed in different locations. In still further embodiments, a computer server system may refer to at least one of a computer server and a database.

Such a computer server 305 may be used in a system shown in FIG. 1. The computer server 305 may include several different components such as a processor bank 310, storage device bank 315, one or more software applications, which may be executed by a processor to form specifically-configured module devices 317, and one or more communication interfaces (335-350). The processor bank 310 may include one or more processors that may be co-located with each other or may be located in different parts of the computer server 305. The storage device bank 315 may include one or more storage devices. Types of storage devices may include memory devices, electronic memory, optical memory, and removable storage media. The one or more modules 317 may include a product safety module 320, a control module 322, a database management module 324, and a product identification module 326. The modules 317 may be implemented by the one or more processors in the processor bank 310.

The computer server 305 may receive consumer identification information and product identification information from the mobile computing device over the one or more communication interfaces (335-350). The database management module 324 may then store the product identification information in a consumer products database based on the consumer identification information. Further, the database management module 324 may link or associate the consumer identification information with the product identification information in the consumer products database. Such a consumer products database may be stored in the storage device bank 315 or stored in an external database.

The product safety module 320 may transmit one or more requests to a third party database at one or more time intervals (at regular or aperiodic time intervals) over the one or more communication interfaces 335-350. Each request is for one or more product recall notices issued since a previous time interval by the third party database. A third party database may be a government database, a manufacturer database, independent agency database. Further, a government agency, product manufacturer, or an independent agency (consumer or product watchdog group) may issue product recall notices at different time intervals when a product defect has been discovered. The time intervals for sending a request for product recall notice(s) may be any time interval such as an hourly, daily, weekly, monthly, etc. as well as aperiodic time intervals. Further, the computer server 305 may receive one or more product recall notices from the third party database through the one or more communication interfaces 335-350. The product safety module 320 may process the one or more received product recall notices to determine the product identification information of the recalled/defective product.

Moreover, the determined product information may be provided to the database management module 324 such that consumer product database is searched based on the determined product identification information. Further, the database management module identifies the consumer identification information (could be for one or more consumers) associated with/based on the determined product identification information.

In addition, the product safety module 320 may generate a message that includes a notification of the one or more product recall notices for a consumer based on the identified consumer identification information and the one or more product recall notices. Such a notification may be sent through the one or more communication interfaces 335-350. The message that includes the notification may be a text message, voice message, email message, fax message, postal message, website update, and RSS.

In one embodiment, the product identification module 326 may receive product data from a consumer computing device described herein. The product identification module 326 determines the product identification information based on the received product data. In one embodiment, the product identification module 326 may send a query to a search engine, database, and or any other information repository (e.g. proprietary database) over the Internet or network through one of the communication interfaces 335-350 based on the received product data. This may include sending the captured image to the search engine or information repository. Such a search engine or information repository may send a response to the computer server 305 and product identification module 326 that includes product identification information. Alternatively, the product identification module 326 may send a query to a database stored in the storage device bank 315 based on the received product data. Such a database may send a response to the product identification module 326 that includes product identification information.

A control module 322 may implement hardware and software functions that assist in performing certain tasks for the computer server 305 such as providing access to a communication network, executing an operating system, managing software drivers for peripheral components, processing information, user interface computer programs, debugging and troubleshooting software tools.

Each of the communication interfaces (335-350) may be software or hardware associated in communicating to other devices. The communication interfaces (335-350) may be of different types that include a user interface, USB, Ethernet, WiFi, WiMax, wireless, optical, cellular, or any other communication interface coupled to a communication network. One or more of the communication interfaces (335-350) may be coupled to a user interface known in the art.

An intra-device communication link 355 between the processor bank 310, storage device bank 315, modules 317, and communication interfaces (335-350) may be one of several types that include a bus or other communication mechanism.

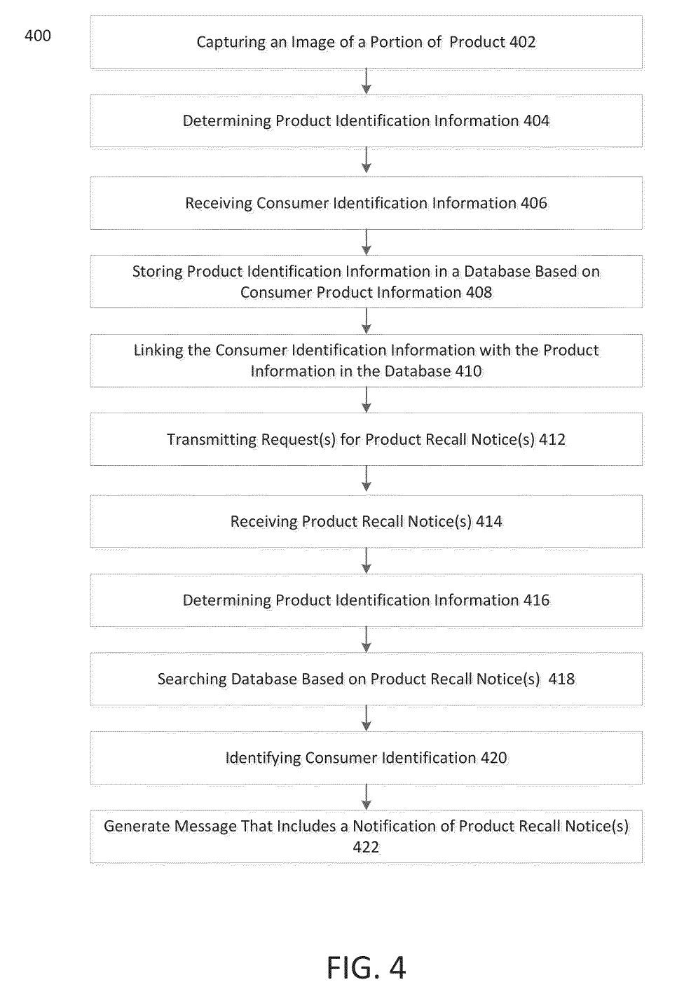

FIG. 4 is a flowchart of a method 400 of providing a product recall notice to a consumer in accordance with some embodiments. The method 400 includes capturing an image of a portion of a product using a mobile computing device, as shown in block 402. Further, the method 400 includes determining product identification information related to the product/image using the mobile computing device, as shown in block 404. The product identification information may be, but not limited to, an image of a portion of a product, a bar code associated with the product, Stock Keeping Unit (SKU) code, Universal Product Code (UPC), European Article Number (EAN), Global Trade Item Number (GTIN), Australian Product Number (APN), Electronic Product Code (EPC), manufacturer name, product name, product description, and batch code.

In addition, the method 400 includes receiving consumer identification information and product identification information from the mobile computing device at a computer server, as shown in block 406. The computer server may be operated by one or more entities such as, but not limited to an online retailer, a retail store, manufacturer, or financial institution.

Moreover, the method 400 includes storing the product identification information in a consumer products database based on the consumer identification information using the computer server, as shown in block 408. The method 400 also includes linking or associating the consumer identification information with the product identification information in the consumer products database using the computer server, as shown in block 410. The method 400 further includes transmitting one or more requests from the computer server to a third party database at one or more time intervals, as shown in block 412. Each request is for one or more product recall notices issued since a previous time interval. In addition, the method 400 includes receiving one or more product recall notices from the third party database using the computer server, as shown in block 414. The third party database may be, but not limited to, a government database, a product manufacturer database, and independent agency database. An independent agency may be a consumer or product watchdog group.

Moreover, the method 400 includes determining the product identification information based on the one or more product recall notices using the computer server, as shown in block 416. The method 400 also includes searching the consumer product database using the computer server based on the determined product information, as shown in block 418. Further, the method 400 includes identifying the consumer identification information based on the determined product identification information using computer server, as shown in block 420. In addition, the method 400 includes generating a message that includes a notification of the one or more product recall notices for a consumer based on the identified consumer identification information and the one or more product recall notices using the computer server, as shown in block 422. The message that includes the notification may be but is not limited to, a text message, voice message, email message, fax message, postal message, website update, and RSS. In some embodiments, steps of the method 400 that are performed by a mobile computing device may be performed by any consumer computing device described herein.

Note, persons of ordinary skill in the art would understand that a POS terminal or a desktop computer may be used instead of a mobile computing devices described herein

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
capturing an image of a portion of a product using a mobile computing device;
determining product identification information related to the product using the mobile computing device;
receiving consumer identification information and product identification information from the mobile computing device at a financial institution computer server;
storing the product identification information in a consumer products database based on the consumer identification information using the financial institution computer server;
linking the consumer identification information with the product identification information in the consumer products database using the financial institution computer server;
transmitting one or more requests from the financial institution computer server to a third party database at one or more time intervals wherein each request is for one or more product recall notices issued since a previous time interval;
receiving one or more product recall notices from the third party database using the financial institution computer server;
determining the product identification information based on the one or more product recall notices using the financial institution computer server;
searching the consumer product database using the financial institution computer server based on the determined product information;
identifying the consumer identification information based on the determined product identification information using the financial institution computer server;
generating a message that includes a notification of the one or more product recall notices for a consumer based on the identified consumer identification information and the one or more product recall notices using the financial institution computer server.

2. The method of claim 1, wherein the product identification information is at least one of an image of a portion of a product, a bar code associated with the product, Stock Keeping Unit (SKU) code, Universal Product Code (UPC), European Article Number (EAN), Global Trade Item Number (GTIN), Australian Product Number (APN), Electronic Product Code (EPC), manufacturer name, product name, and batch code.

3. The method of claim 1, wherein the third party database is at least one of government database, manufacturer database, and independent agency database.

4. The method of claim 1, wherein the message that includes the notification is at least one of a text message, voice message, email message, fax message, postal message, website update, and RSS.

5. A method comprising:
receiving consumer identification information and product identification information from a computing device at a remote computer server;
storing the product identification information in a consumer products database based on the consumer identification information using the remote computer server;
linking the consumer identification information with the product identification information in the consumer products database using the remote computer server;
transmitting one or more requests from the remote computer server to a third party database at one or more time intervals wherein each request is for one or more product recall notices issued since a previous time interval;
receiving one or more product recall notices from the third party database using the remote computer server;
determining the product identification information based on the one or more product recall notices using the remote computer server;
searching the consumer product database using the remote computer server based on the determined product identification information;
identifying the consumer identification information based on the determined product identification information using the remote computer server;
generating a message including a notification of the one or more product recall notices for a consumer based on the identified consumer identification information and the one or more product recall notices using the remote computer server.

6. The method of claim 5, further comprising:
capturing an image of a portion of a product using the computing device wherein the computing device is a mobile computing device;
determining product identification information related to the product using the mobile computing device.

7. The method of claim 5, further comprising:
capturing an image of a portion of a product using a scanner of the computing device wherein the computing device is a point-of-sale (POS) terminal;
determining product identification information related to the product using the POS terminal.

8. The method of claim 5, further comprising:
receiving an image of a portion of a product using a computing device wherein the computing device is a personal computer;
transmitting the image of the portion of the product to the remote computer server;
determining product identification information related to the product using the remote computer server.

9. The method of claim 5, wherein the remote computer server is operated by one or more entities, the one or more entities is at least one of an online retailer, a retail store, manufacturer, and a financial institution.

10. The method of claim 5, wherein the product identification information is at least one of an image of a portion of a product, a bar code associated with the product, Stock Keeping Unit (SKU) code, Universal Product Code (UPC), European Article Number (EAN), Global Trade Item Number (GTIN), Australian Product Number (APN), Electronic Product Code (EPC), manufacturer name, product name, and batch code.

11. The method of claim 5, wherein the third party database is at least one of a government database, manufacturer database, and independent agency database.

12. The method of claim 5, wherein the message that includes the notification at least one of a text message, voice message, email message, fax message, postal message, website update, and RSS.

13. A system comprising:
a mobile computing device having an image capture device, one or more storage devices, one or more processors and one or more modules implemented by the one or more processors, wherein:
the image capture device captures an image of a portion of a product;
the one or more modules are configured to:
determine product identification information related to the product;
transmit consumer identification information and product identification information to a financial institution computer;
a financial institution computer server coupled to one or more storage devices storing a consumer products database, one or more processors, and one or more modules implemented by the one or more processors, wherein:
the one or more modules are configured to:
receive consumer identification information and product identification information from the mobile computing device;
store the product identification information in a consumer products database based on the consumer identification information;
link the consumer identification information with the product identification information in the consumer products database;
transmit one or more requests to a third party database at one or more time intervals wherein each request is for one or more product recall notices issued since a previous time interval;
receive one or more product recall notices from the third party database;
determine the product identification information based on the one or more product recall notices;
search the consumer product database based on the determined product identification information;
identify the consumer identification information based on the determined product identification information;
generate a message that includes a notification of the one or more product recall notices for a consumer based on the identified consumer identification information and the one or more product recall notices.

14. The system of claim 13, wherein the product identification information is at least one of an image of a portion of a product, a bar code associated with the product, Stock Keeping Unit (SKU) code, Universal Product Code (UPC), European Article Number (EAN), Global Trade Item Number (GTIN), Australian Product Number (APN), Electronic Product Code (EPC), manufacturer name, product name, and batch code.

15. The system of claim 13, wherein the third party database is at least one of a government database, manufacturer database, and independent agency database.

16. The system of claim 13, wherein the message that includes the notification is at least one of a text message, voice message, email message, fax message, postal message, website update, and RSS.
